(19) United States
(12) Patent Application Publication
(10) Pub. No.: US 2006/0190558 A1
(43) Pub. Date: Aug. 24, 2006

(54) Computer system and storage device

(76) Inventors: Akitsugu Kanda, Yamato (JP); Etsutaro Akagawa, Kawasaki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/092,837

(22) Filed: Mar. 30, 2005

(30) Foreign Application Priority Data
Feb. 9, 2005 (JP) 2005-032892

(51) Int. Cl. G06F 15/16

(52) U.S. Cl. 709/217

(57) ABSTRACT

When the system administrator, using an management terminal 600, changes the settings of a storage device 200, a log concentration device 400 is notified of the settings. These settings include the IP address of peripheral servers 300. On the basis of the IP address of the peripheral servers 300 of which it is notified by the storage device 200, the log concentration device 400 changes the log concentration targets. As a result, even if the system configuration of the computer system including the storage device should be modified, the log concentration device can concentrate the appropriate logs from the servers.

### CLAIM OF PRIORITY

The present application claims priority form Japanese application P2005-32892 filed on Feb. 9, 2005, the content of which is hereby incorporated by reference into this application.

### BACKGROUND

The present invention relates to a technology for log concentration in a computer system comprising a computer and a storage device.

Storage devices that receive and accumulate data from computers connected via a network operate in coordination with peripheral server devices of various kinds, such as DNS (Domain Name System) servers, NTP (Network Time Protocol) servers, NIS (Network Information Service) servers, domain controllers, and the like.

Typically, these kinds of server devices monitor communications history, changes in operating settings and the like, and keep this as log information. Logs recorded by individual servers can be transferred over a network by means of a protocol such as syslog or snmp, for concentration by a single server device. For example, the syslog protocol, which is a protocol for network transfer of logs recorded by server devices, is described in C. Lonvick, “RFC 3164—The BSD Syslog Protocol” August 2001, Internet Engineering Task Force (IETF). Through administration by concentrating, at a single location, logs created by server devices, the administrator can efficiently monitor the network to ascertain which server device has experienced a fault that is diminishing its availability. Herein, the device that concentrates logs from server devices will be termed the log concentration device.

The cited reference by C. Lonvick may be accessed at
URL: http://www.faqs.org/rfcs/rfc3164.html or
URL http://www.amris.co.jp/netdocs/rfc3164_j.html.

### SUMMARY

Where logs are concentrated by a log concentration device, the administrator, in the event that the computer system configuration is modified or the method of operation is reviewed, must in association therewith not only notify the storage device of the change, but also make settings on the log concentration device to make it operate normally. Taking as an example a case where a new server device is added to the computer system, it is necessary to register the new server device with the storage device that will operate in coordination with the new server device, and it is necessary to perform in the log concentration device separate registration of the server device targeted for log concentration. Where the system operates using the Internet or an intranet, registration of the server device is carried out by specifying a new IP address.

This setting procedure represented an exceedingly cumbersome process for the administrator. Thus, there was always a risk that an administrator would first make the storage device settings required for system operation, and put off making the log concentration device settings, which are not directly related to the operation of the storage device. If this happens, the log concentration device continues to run with the old settings, making it possible that the system will operate without the necessary logs being concentrated.

With a view to addressing the problem outlined above, it is needed to provide technology whereby the appropriate logs can be concentrated from servers by the log concentration device, even in the event of a modification of the system configuration of a computer system including a storage device.

One aspect of the present invention points out a computer system. The computer system comprises: a computer; a storage device that stores data received from said computer over a network; and a log concentration device that concentrates log information from a server device group connected to said network,

wherein said storage device comprises:

a settings information receiving unit that receives as a part of settings information an address of a predetermined server device that, of said server device group, is required for operation of said storage device on said network; an operational setting unit that performs settings to initiate operation on said network on the basis of said received settings information; and a settings information notifying unit that notifies said log concentration device of said address included in said settings information;

and wherein said log concentration device comprises: a concentration target designating unit that designates a server device targeted for concentration of log information, on the basis of said address given in the notification by said storage device; and a log information concentrating unit that concentrates said log information from said designated server device.

Regarding the computer system having such an arrangement, the log concentration device is also notified of the settings for the storage device, whereby the log concentration device, on the basis of the address included in these settings, can readily designate the server device for which log concentration is to be carried out. That is, in the event that the system configuration of the computer system has been modified, simply by modifying the settings of the storage device, the settings of the log concentration device are modified automatically as well. As a result, a smaller burden is placed on the system administrator.

According to the computer system of the present invention, since the log of the server device that operates in coordination with the storage device is concentrated by the log concentration device, in the event of a fault that diminishes the availability of the storage device, the cause thereof and countermeasures can be carried out efficiently, not only for the storage device by itself, but together with the peripheral server device thereof.

In the aforementioned computer system, the storage device may receive said settings information from an management terminal connected to said storage device.

By means of this arrangement, even where the storage device is situated at a remote location, the system administrator nevertheless is able to readily modify the settings of the storage device.

In the aforementioned computer system, said management terminal may be connected to said storage device by an management network different from said network.

By means of this arrangement, in the event that a fault should occur on the network connecting the storage device and the computer, in the event that the configuration of the network has been modified, or in the event that network traffic is heavy, storage device settings nevertheless is made reliably.

In the aforementioned computer system, said log concentration device may be connected to said management network; and said network and said management network may be connected by a gateway that selectively passes said log information.

With this arrangement, since log data sent from a server device reaches the log concentration device through the aforementioned gateway, it is possible to avoid an appreciable increase in traffic on the network connecting the computer and the storage device. Also, with this arrangement, admission of data other than log information into the management network is restricted, so that an increase in traffic on the management network can be avoided.

In the aforementioned computer system, by filtering on the basis of addresses registered in the storage device, log information for a designated server device is extracted from all log information concentrated from said server device group.

By means of this arrangement, the log concentration device, while concentrating logs sent from the various server devices connected to the computer system, is able to extract only the log relating to the server device associated with operation of the storage device.

In the aforementioned computer system, said storage device may receive a port number in addition to said address as said settings information; and said log concentration device, on the basis of said address and said port number, may designate the server device targeted for concentration of said log information.

With this arrangement, in the event that several server programs are executed on a given server device, it is possible to concentrate logs on an individual server program basis.

In the aforementioned computer system, said server device group may include at least one type of server selected from a DNS server, an NTP server, a domain controller, and an NIS server. It may also include one or several servers selected from among, for example, a print server, file server, Web server, FTP server, DHCP server, remote access server, and the like.

The invention may also be constituted as a storage device such as the following. Specifically, it may reside in a storage device for storing data received from a computer over a network, comprising:

a settings information receiving unit that receives as a part of settings information an address of a predetermined server device required for operation of said storage device to be operated on said network;

an operational setting unit that carries out settings to initiate operation on said network on the basis of said received settings information; and

a log concentration control unit that notifies a log concentration device that concentrates log information from a server device group connected to said network, of the address included in said received settings information, in order to cause said log concentration device to concentrate log information of the server device corresponding to said address from among said server device group.

Besides the computer system and the storage device taught hereinabove, the present invention could also be constituted, for example, as a log concentration method in a computer system, a log concentration control method by a storage device, or a computer program by which these methods are carried out by computer. The computer program may be embodied as a data signal in a carrier wave, or may be recorded onto a computer-readable recording medium. The recording medium could consist, for example, of a CD-ROM, flexible disk, magnetooptical disk, DVD or the like.

### BRIEF DESCRIPTION OF THE DRAWINGS

FIG. 1 is an illustration showing the arrangement of a computer system 10.

FIG.2 is a simplified illustration of the hardware arrangement of a storage device 200.

FIG. 3 is a simplified illustration of the hardware arrangement of a log concentration device 400.

FIG. 4 is a simplified illustration of the hardware arrangement of an management terminal 600.

FIG. 5 is a flowchart of a settings modification process.

FIG. 6 is an illustration of an exemplary settings screen.

FIG. 7 is an illustration of an exemplary monitoring target table WT.

FIG. 8 is an illustration of an exemplary filtering list FL.

FIG. 9 is an illustration of exemplary filtering results.

FIG. 10 is a flowchart of a log concentration process.

### DESCRIPTION OF THE PREFERRED EMBODIMENTS

A better understanding of the effects and advantages of the invention is provided through the following description of the embodiments of the invention based on preferred embodiments, made in the order set forth below.
A. Arrangement of A Computer System:
B. Device Hardware Arrangements:
   (B1) Storage Device:
   (B2) Log Concentration Device:
   (B3) Management Terminal:
C. Processes:
   (C1) Settings Modification Process:
   (C2) Log Concentration Process:
D: Effects:
E. Variation Embodiments:

### A. Arrangement of Computer System

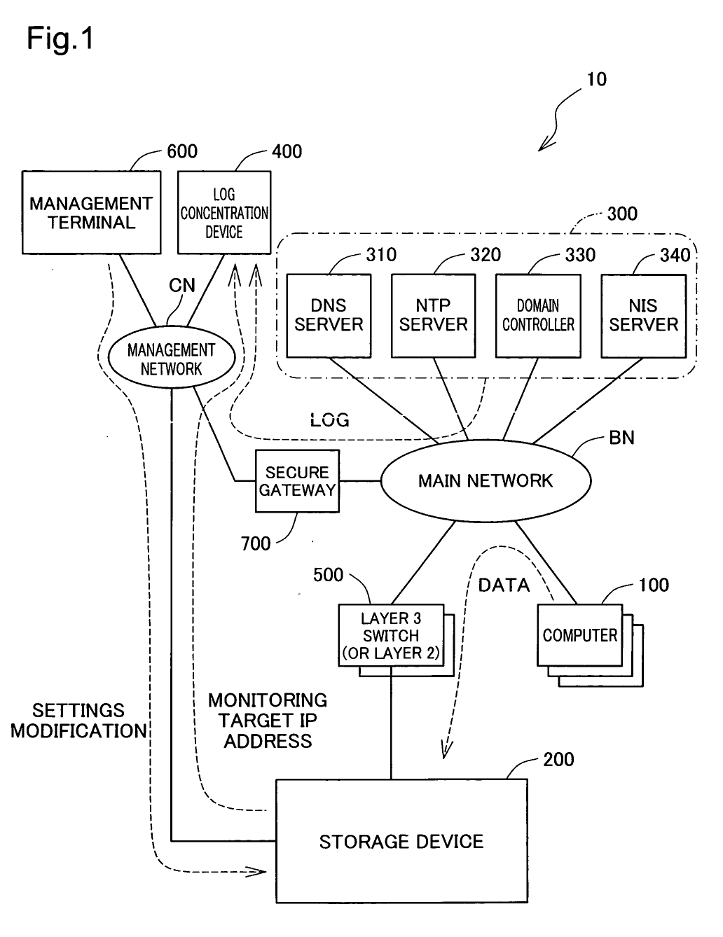

FIG. 1 is an illustration showing the arrangement of a computer system 10 as a preferred embodiment of the invention. As shown in the drawing, the computer system 10 of the preferred embodiment includes a main network BN and an management network CN, these networks having connected thereto a computer 100, a storage device 200 that stores data received from this computer 100, a log concentration device 400 that collects and concentrates logs from peripheral servers 300, and so on.

A plurality of computers 100 and peripheral servers 300 are connected to the main network BN. A storage device 200 is connected via a Layer 3 switch 500. The Layer 3 switch 500 is a network relay device that determines the destination of packets in the network layer of the OSI model, and forwards them. Data sent from a computer 100 passes through the main network BN and the Layer 3 switch 500, and is stored in the storage device 200. Of course, the storage device 200 is capable not only of storing data, but also of outputting data in response to a request from a computer 100. In the preferred embodiment, a Layer 3 switch 500 is used to connect the storage device 200 with the main network BN, but a Layer 2 switch could also be used. A Layer 2 switch is a device that determines the destination of packets in the data link layer of the OSI model, and forwards them.

As shown in the drawing, the peripheral servers 300 include a DNS server 310, an NTP server 320, a domain controller 330, and an NIS server 340.

The DNS server 310 is a server that translates domain names into IP addresses in response to queries from the storage device 200 or the computers 100.

The NTP server 320 is a server that sends the correct time in response to queries from the storage device 200 or the computers 100.

The domain controller 330 is a server that, in a Windows™ based network environment, administers information relating to users and security, and performs user authentication. That is, where the computer system 10 is built in Windows based environment, the server is required in order for the storage device 200 and the computers 100 to participate and operate in the computer system 10.

The NIS server 340 is a server that administers user information in a UNIX™ network environment. That is, where the computer system 10 is built in a UNIX environment, the server is required in order for the storage device 200 and the computers 100 to participate and operate in the computer system 10.

In addition to the servers mentioned above, a DHCP (Dynamic Host Configuration Protocol) server, print server, remote access server, file server, Web server, FTP server and the like may also be connected to the main network BN as peripheral servers 300.

To the management network CN are connected an management terminal 600 for making settings of the storage device 200, and a log concentration device 400 for concentrating logs from all of the peripheral servers 300 connected to the main network BN, based on a protocol termed SYSLOG. The storage device 200 connected to the main network BN is also connected to this management network CN. The management network CN is a network that has been built separate from the main network BN through which large numbers of packets flow, in order to be able to efficiently carry out concentration of logs from the storage device 200 and the peripheral servers 300.

The management network CN and the main network BN are connected via a secure gateway 700. The secure gateway 700 is a device that selectively lets through only log data and control data exchanged among the peripheral servers 300 on the main network BN and the log concentration device 400 on the management network CN. The secure gateway 700 is able to monitor packets flowing through the two networks and selectively let through only log data and control data, by letting through only packets that use UDP port 514. With SYSLOG, which is a log transfer protocol, the UDP port number is used by default. When SNMP (Simple Network Management Protocol) is used for log concentration, only packets destined for UDP port 161 are let through.

In the computer system 10 having the configuration described above, when the system administrator modifies the settings of the storage device 200 using the management terminal 600, the log concentration device 400 is also notified of the settings. The IP address etc. of the peripheral server 300 is included in the settings notification. On the basis of the IP address etc. of the peripheral server 300 about which it is notified by the storage device 200, the log concentration device 400 modifies the log concentration target. Specifically, as long as settings are made for the storage device 200, the log concentration target of the log concentration device 400 will be modified automatically, and the log of the peripheral server 300 related to operation of the storage device 200 will be concentrated by the log concentration device 400.

### B. Device Hardware Arrangements

### (B1) Storage Device

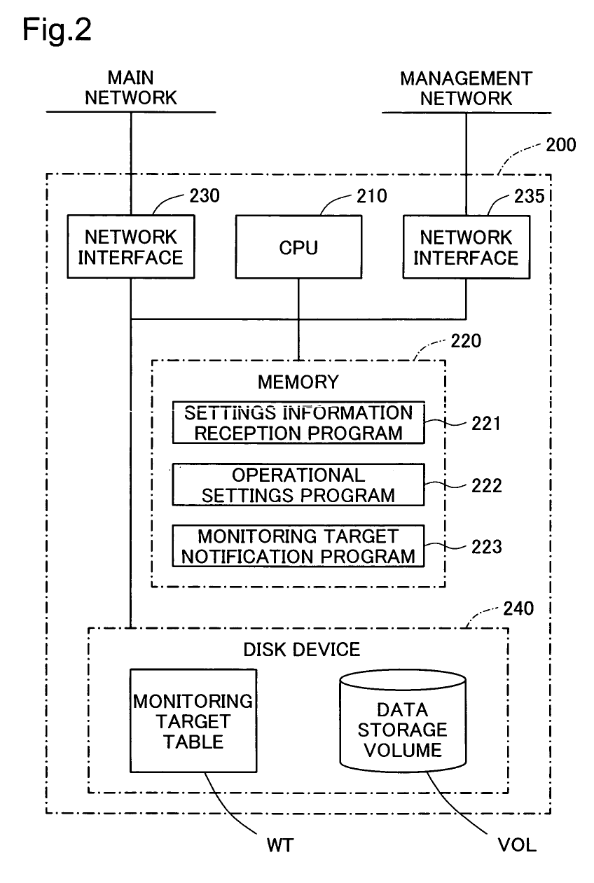

FIG.2 is a simplified illustration of the hardware arrangement of the storage device 200. The storage device 200 of the preferred embodiment is configured as an NAS (Network Attached Storage) device used connected directly to the network; as shown in the drawing, it comprises a CPU 210, memory 220, two network interfaces 230, 235, and a disk device 240.

The two network interfaces 230, 235 are connected respectively to the main network BN and the management network CN, and perform communications control vis-à-vis these networks.

A monitoring target table WT is stored on the disk device 240, on which there is also secured a data storage volume VOL. IP addresses included in settings information received from the management terminal 600 via the management network CN is recorded in the monitoring target table WT. Then log concentration device 400, described later, is notified of the IP addresses recorded in the monitoring target table WT, and targets these for log monitoring. The data storage volume VOL, on the other hand, stores data received from computers 100 via the main network BN.

In memory 220 are stored a settings information reception program 221, an operational settings program 222, and a monitoring target notification program 223. The CPU 210 executes these programs while using an area that is part of the memory 220 as the work area. These programs may also installed on the disk device 240, and sequentially read out from memory 220 and executed by the CPU 210.

The settings information reception program 221 has the function of presenting a settings screen to a Web browser that is run from the management terminal 600, and receiving through the Web browser information for various settings needed to operate the storage device 200 on the main network BN. This settings information includes, for example, IP addresses and port numbers for the DNS server 310, the NTP server 320, the domain controller 330, the NIS server 340 or other peripheral servers 300. Once settings information has been received from the management terminal 600, the settings information reception program 221 registers the IP addresses etc. included in the information in the monitoring target table WT.

The operational settings program 222 is a program for carrying out the settings needed to start operation of the storage device on the main network BN, on the basis of settings information input by the settings information reception program 221.

The monitoring target notification program 223 is a program for sending IP addresses etc. registered in the monitoring target table WT, to the log concentration device 400 via the management network CN.

### (B2) Log Concentration Device

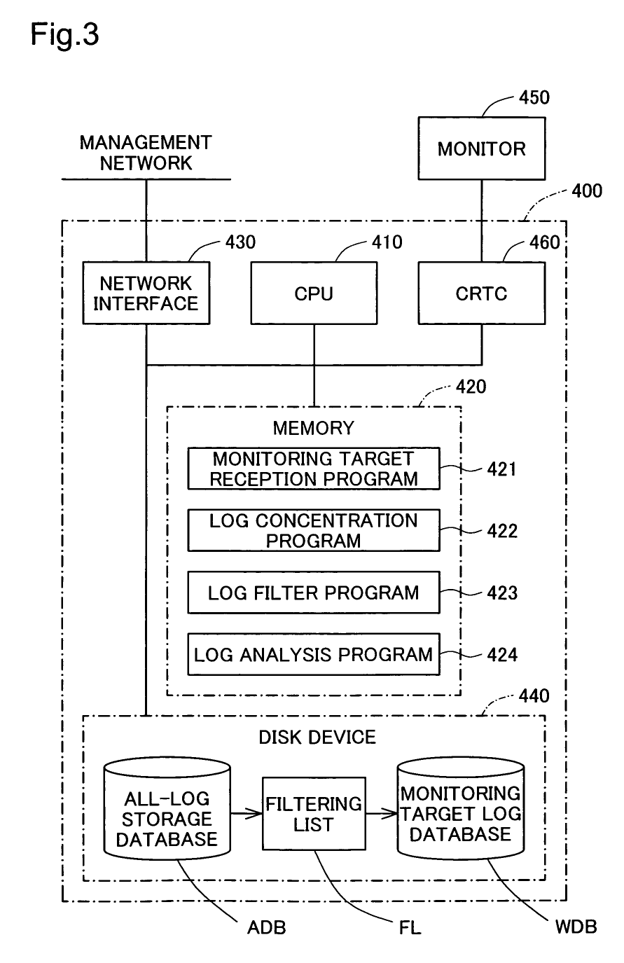

FIG. 3 is a simplified illustration of the hardware arrangement of the log concentration device 400. The log concentration device 400 of the preferred embodiment is composed of an ordinary computer, comprising a CPU 410, memory 420, a network interface 430, a disk device 440, and a CRT controller 460 for display control of a monitor 450.

The network interface 430 is connected to the management network CN, and performs communication control between the log concentration device 400 and the management network CN.

An all-log storage database ADB, a monitoring target log database WDB, and a filtering list FL are stored in the disk device 440. In the all-log storage database ADB is recorded all log information received from peripheral servers 300 and the Layer 3 switch 500 via the secure gateway 700. The monitoring target log database WDB, on the other hand, records logs extracted by means of the filtering list FL, from among the logs recorded on the all-log storage database ADB.

In memory 420 are stored a monitoring target reception program 421, a log concentration program 422, a log filter program 423, and a log analysis program 424. The CPU 410 executes these programs while using area that is part of the memory 420 as the work area. These programs may also installed on the disk device 440, and sequentially read out from memory 420 and executed by the CPU 410.

The monitoring target reception program 421 is a program for receiving IP addresses and port numbers of peripheral servers 300 selected as targets for monitoring (targets for log concentration). The received IP addresses and other information are registered in the filling list FL.

The log concentration program 422 is a program that, using the SYSLOG protocol, concentrates from the peripheral servers 300 and the Layer 3 switch 500 logs that record operating conditions of the devices. The concentrated logs are recorded in the all-log storage database ADB. A protocol such as SNMP (Simple Network Management Protocol) could be used instead of SYSLOG.

The log filter program 423 is a program for extracting, from the logs recorded in the all-log storage database ADB, a log corresponding to an IP address etc. registered in the filtering list FL, and recording it in the monitoring target log database WDB.

The log analysis program 424 is a program for analyzing logs recorded in the monitoring target log database WDB, and creating charts and graphs for display on the monitor 450.

### (B3) Management Terminal

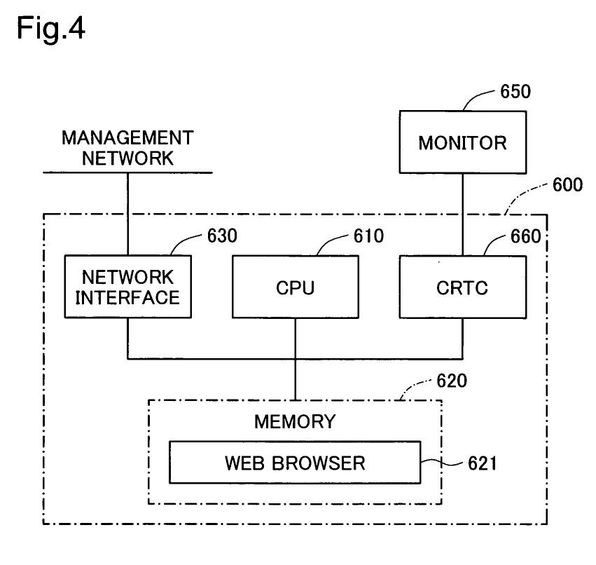

FIG. 4 is a simplified illustration of the hardware arrangement of the management terminal 600. The management terminal 600 of the preferred embodiment is composed of an ordinary computer, comprising a CPU 610, memory 620, a network interface 630, a monitor 650, and a CRT controller 660.

The network interface 630 is connected to the management network CN, and performs communication control between the management terminal 600 and the management network CN.

A Web browser 621 is stored in memory 620. The CPU 610 executes the Web browser 621 while using an area that is part of memory 620 as the work area. The Web browser 621 may also installed on a disk device (not shown) and sequentially read out from memory 620 and executed by the CPU 610.

The Web browser 621 has the function of receiving a settings screen provided by the storage device 200 via the management network CN, and displaying it on the monitor 650; it also has the function of sending to the storage device 200 settings information of various kinds entered from this settings screen by the system administrator.

### C. Processes

### (C1) Settings Modification Process

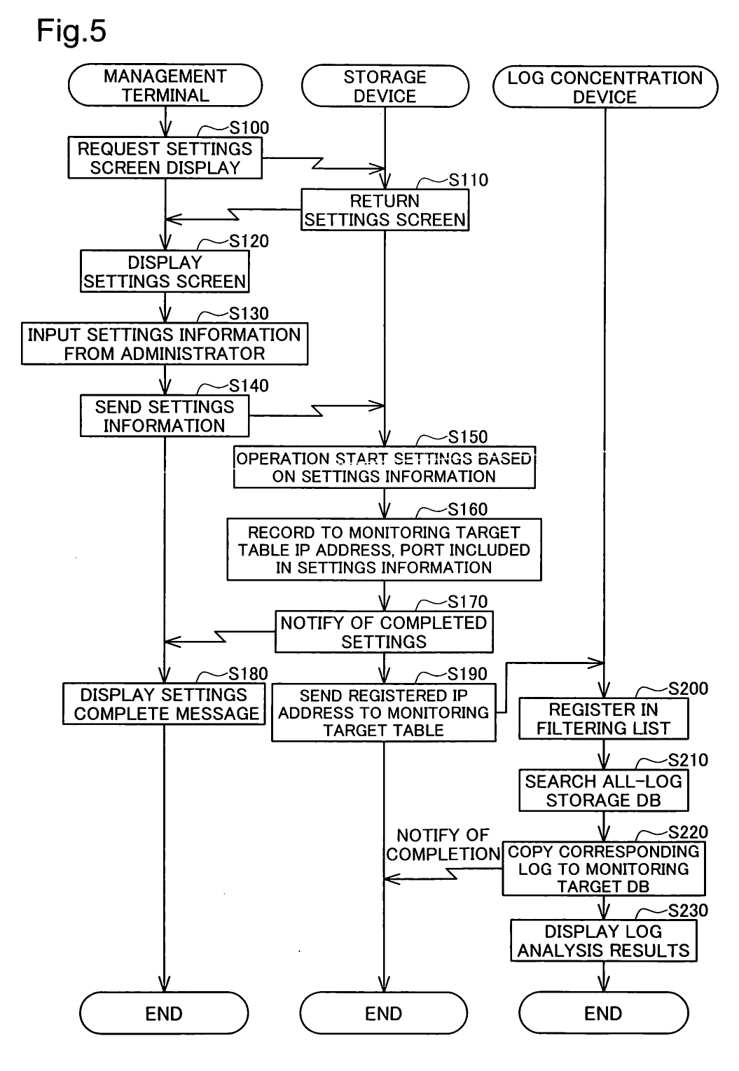

FIG. 5 is a flowchart of the settings modification process executed among the management terminal 600, the storage device 200, and the log concentration device 400. The process is used in the event that, for example, the peripheral server 300 configuration has been modified, in order to establish communication between the storage device 200 and the main network BN, enable normal operation of the storage device 200 over the main network BN. This settings modification process is executed by an operation by the system administrator from the Web browser of the management terminal 600, mainly when one of the following events ((a)-(e)) has occurred.

(a) In the event that the computer system 10 has been newly set up.

(b) In the event that the IP address of a peripheral server 300 has changed after starting operation of the computer system 10.

(c) In the event that an independently operated peripheral server 300 has become redundant.

(d) In the event that a new NIS server 340 has been set up, in order to initiate file sharing using NFS (Network File System).

(e) In the event that a new domain controller has been set up, in order to initiate file sharing using CIFS (Common Internet File System).

In the settings modification process, first, the system administrator enters the IP address of the storage device 200 on the management network CN, in the URL (Uniform Resource Locator) input field of the Web browser run on the management terminal 600. Thereupon, the Web browser of the management terminal 600 sends a settings screen display request to the storage device 200 via the management network CN (Step S100). When the storage device 200 receives the display request, a predetermined settings screen described in HTML is returned to the management terminal 600 via the management network CN (Step S110). When the management terminal 600 receives this settings screen, is displays it on the Web browser (Step S120).

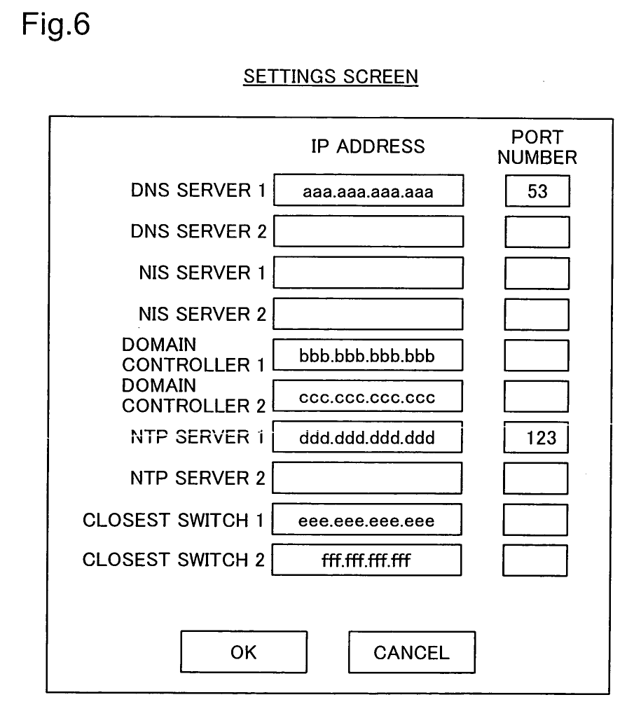

FIG. 6 is an illustration of an exemplary settings screen displayed on the Web browser of the management terminal 600. As shown in the drawing, this settings screen displays menu items for inputting IP address and port number for the DNS server 310, NIS server 340, domain controller 330, NTP server 320, and nearest Layer 3 switch 500. Since these devices are provided in sets of two for redundancy, two IP address and port number fields are provided for each. The system administrator does not need to enter all of the menu items displayed on the settings screen; where the peripheral server 300 in question is not present on the main network BN, it will not be necessary to input an IP address and port number. When the default port number is used for a peripheral server 300, it will not be necessary to input a port number.

When the system administrator has input IP addresses and port numbers (these parameters are referred to hereinafter as “settings information”) for the peripheral servers 300 from the settings screen described above (Step S130), the management terminal 600 sends this settings information to the storage device 200 (Step S140).

Upon receiving the settings information from the management terminal 600, the storage device 200 establishes a connection to the main network BN, and makes settings for initiating operation on the main network BN (Step S150). The IP addresses and port numbers contained in the settings information are registered in a monitoring target table WT (Step S160).

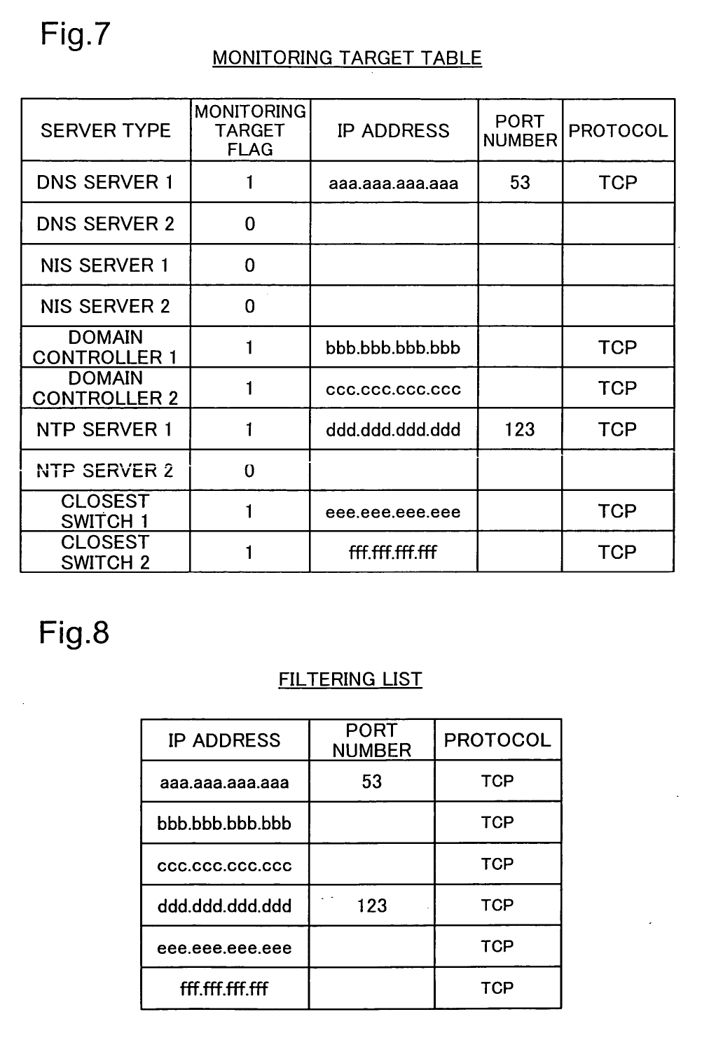

FIG. 7 is an illustration of an exemplary monitoring target table WT. As shown in the drawing, in the monitoring target table WT are registered, for each type of peripheral server 300, a monitoring target flag indicating whether that peripheral server is a monitoring target, an IP address, a port number, and a protocol targeted for monitoring (TCP or UDP). For peripheral servers whose IP addresses have been established in settings information received from the management terminal 600, a “1” is recorded in the monitoring target flag. Regarding designation of the protocol, usually, the default protocol is designated. In the settings screen shown in FIG. 6, protocol designation can be set as an optional item.

When the process of registration in the monitoring target table WT has been completed by the aforementioned Step S160, the storage device 200 notifies the management terminal 600 to the effect that settings have been completed for the storage device 200 (Step S170). When the management terminal 600 receives this notification, it displays on the Web browser a message to the effect that settings have been completed for the storage device 200 (Step S180).

Next, when the storage device 200 reads from the monitoring target table WT those IP addresses whose monitoring target flag status is “1”, it designates the corresponding port number and protocol, and sends this information to the log concentration device 400 (Step S190). Upon receiving this information, the log concentration device 400 registers the information in a filtering list FL (Step S200). FIG. 8 is an illustration of an exemplary filtering list FL.

Next, the log concentration device 400 searches the log already recorded in the all-log storage database ADB for logs that correspond to the IP addresses, port number, and protocol types registered in the filtering list FL (Step S210). The details of the processing method by which the log concentration device 400 concentrates logs from the peripheral servers 300 will be described later. The retrieved logs are copied to a monitoring target log database WB (Step S220).

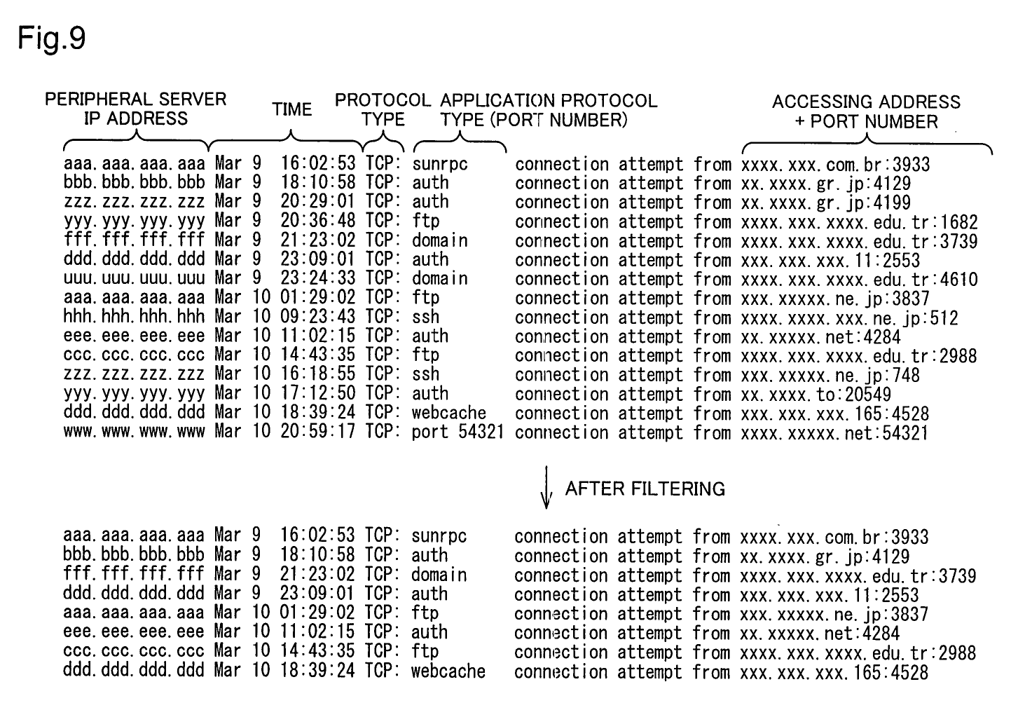

FIG. 9 is an illustration of exemplary log filtering results. At the top of the drawing are shown the logs recorded in the all-log storage database ADB, and at the bottom of the drawing are shown the logs copied to the monitoring target log database WB. As shown the drawing, each log is composed of a peripheral server 300 IP address, time stamp, protocol type (TCP or UDP), type of application protocol by which the computer 100 on the main network BN attempted access, and the access source address (including port number). The application protocol type corresponds to port number on a one-to-one basis; for example, “domain” is accessed on port 53, and “ssh” is accessed on port 22.

When copying of logs to the monitoring target log database WB has been completed, the log concentration device 400 sends to the storage device 200 completion notification to the effect that log filtering is finished. The log concentration device 400 then analyzes the filtered results and generates a chart or graph, displaying the results of analysis on the monitor 450 (Step S230). With this, the settings modification process sequence comes to a finish.

### (C2) Log Concentration Process

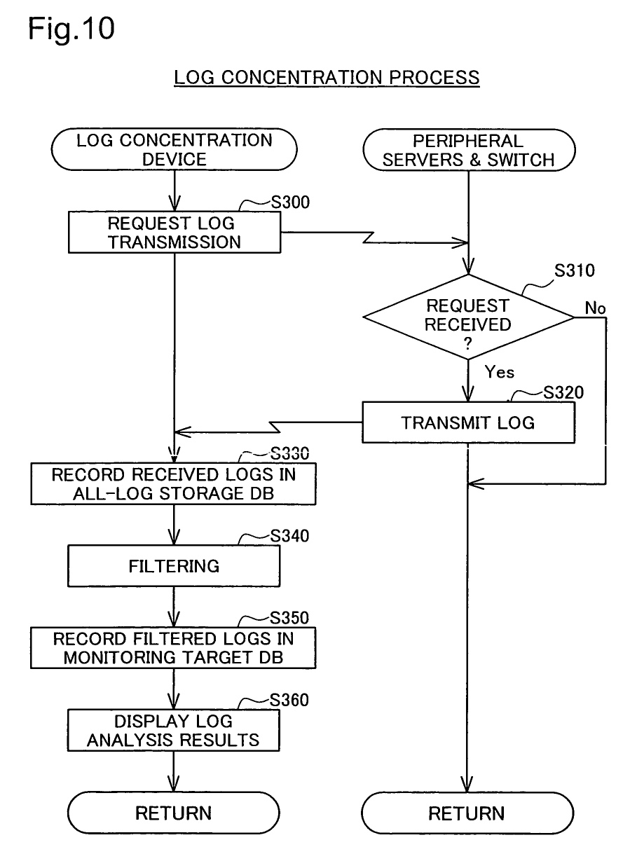

FIG. 10 is a flowchart of the log concentration process by which the log concentration device 400 periodically concentrates logs from the peripheral servers 300 and the Layer 3 switch 500. In the following description, the Layer 3 switch 500 is considered to be included among the peripheral servers 300.

First, the log concentration device 400 sends a log transmission request to all of the peripheral servers 300 connected to the main network BN, via the secure gateway 700 (Step S300). At this time, it is assumed that the IP addresses of all of the peripheral servers 300 connected to the main network BN have been previously stored in the log concentration device 400, with log transmission requests being sent to these IP addresses.

When a peripheral server 300 receives a transmitted request (Step S310: Yes), it sends the log maintained by itself to the log concentration device 400 via the secure gateway 700 (Step S320).

Upon receiving a log from a peripheral server 300, the log concentration device 400 records the received log in the all-log storage database ADB (Step S330). Next, filtering is carried out on the basis of the filtering list FL established by the settings modification process described previously (Step S340), and logs corresponding to the filtering list FL are copied to the monitoring target log database WB (Step S350).

When log filtering is completed, the log concentration device analyzes the logs copied to the monitoring target log database WB, and creates a chart or graph. The results of analysis are then displayed on the monitor 650 (Step S360), whereupon the log concentration process sequence comes to a finish.

The log concentration device 400 executes the aforementioned log concentration process on a periodic basis, for example, once hourly or once daily. In association with execution of the log concentration process, a relatively large amount of log data flows across the main network BN, and so the process may be carried out at night, when the computer system 10 is not ordinarily used. While log transmission requests may be sent simultaneously to all peripheral servers 300, in order to hold down the increase in network traffic, it is preferable to transmit them sequentially to the peripheral servers 300 at some appropriate time interval. In the aforementioned Step S300, in the event that the log concentration device 400 cannot ascertain the IP addresses of all of the peripheral servers 300, the log concentration device 400 can broadcast a log transmission request over the main network BN.

### D: Effects

According to the computer system 10 of the preferred embodiment described hereinabove, when the system administrator, using the management terminal 600, changes the settings of the storage device 200, the log concentration device 400 is notified by the storage device 200 of the IP address and port number of the peripheral server 300 whose settings have been changed. On the basis of the IP address etc. of the peripheral server 300 about which it is notified by the storage device 200 in this manner, the log concentration device 400 can change the settings of the filtering list FL. Specifically, simply by changing the settings of the storage device 200, the target for log concentration by the log concentration device 400 can be changed automatically as well, reducing the burden on the system administrator associated with a change in system configuration.

Also, according to the computer system 10 of the preferred embodiment, logs for peripheral servers 300 that operate in linkage with the storage device 200 are recorded into the monitoring target database WDB of the log concentration device 400. Thus, even if a fault that diminishes the availability of the storage device 200 should occur, analysis of the cause of the fault and countermeasures therefor can be carried out efficiently, not only for the storage device by itself, but together with the peripheral server thereof.

In the preferred embodiment, since port numbers of peripheral servers 300 can be designated from the settings screen shown in FIG. 6, even where a plurality of server programs are executed on a given peripheral server 300, logs can be concentrated for each server program. For example, in the case that an NTP server program is executed on the DNS server 310, a log relating to DNS and a log relating to NTP can be concentrated separately.

### E. Variation Embodiments

While the embodiments of the invention have been shown herein through a preferred embodiment, the invention may be reduced to practice in various other modes without departing from the spirit thereof, such as the following variations, for example.

### (E1) Variation Embodiment 1

In the settings modification process of the preferred embodiment, the storage device 200 inputs settings information from the management terminal 600 connected by means of the management network CN. However, by instead providing the storage device 200 with a keyboard or other input device, settings information could be input directly to the storage device 200.

### (E2) Variation Embodiment 2

In the settings modification process and log concentration process depicted in FIG. 5 and FIG. 10, the log concentration device 400 displays the results of log analysis on its own monitor 450. However, the log concentration device 400 could instead sent the analysis results to the Web browser executed on the management terminal 600, for display on the management terminal 600. By so doing, the system administrator can verify the storage device 200 settings and the log analysis results on the same device.

### (E3) Variation Embodiment 3

In the log concentration process depicted in FIG. 10, the peripheral servers 300 receive a log transmission request from the log concentration device 400, and in response transmit their logs to the log concentration device 400. However, the peripheral servers 300 could instead spontaneously transmit their logs to the log concentration device 400, without any request by the log concentration device 400. In this case, in order to avoid a sudden increase in network traffic due to simultaneous output of logs by the peripheral servers 300, it is preferable establish for the peripheral servers 300 appropriate time intervals for log transmission time.

### (E4) Variation Embodiment 4

The log concentration device 400 in the preferred embodiment extracts from the all-log storage database ADB logs corresponding to the filtering list FL, and copies the corresponding logs to the monitoring target database WDB. However, the log concentration device 400 could instead assign an index to logs in the all-log storage database ADB that correspond to the filtering list FL. By so doing, it becomes unnecessary to copy the logs, making it possible to reduce disk capacity.

### (E5) Variation Embodiment 5

In the preferred embodiment, peripheral server IP addresses and port numbers are entered from the settings screen shown in FIG. 6. It would be possible to additionally provide check boxes indicating, for example, “once daily”, “once hourly” or “once per minute” to enable specification, by means of the check boxes, of the timing for concentration of logs from the peripheral servers 300 by the log concentration device 400. The protocol for extracting the log, i.e. TCP or UDP, can also be specified from the settings screen.

### (E6) Variation Embodiment 6

In the preferred embodiment, the log concentration device 400 concentrates logs from all of the peripheral servers 300 connected to the computer system 10, and extracts from among these the logs corresponding to IP addresses registered in the filtering list FL. However, the log concentration device 400 could instead concentrate logs from only peripheral servers 300 corresponding to IP addresses of which notification has been provided by the storage device 200. In this case, in the log concentration process depicted in FIG. 10, the log transmission request could be sent only those peripheral servers 300 corresponding to IP addresses registered in the filtering list FL. By so doing, there are fewer targets for log concentration, reducing the load on the log concentration device 400.

### (E7) Variation Embodiment 7

In the settings modification process depicted in FIG. 5, the processes from Step S210 to Step S230 may be omitted. This is because processes (Step S340-S360) similar to that of the log concentration process described in FIG. 10 can be executed even where these processes are omitted. However, where these processes are carried out in the settings modification process, convenience is improved, as log information of server devices operating in cooperation with the storage device 200 are displayed at the same time that settings for the storage device 200 are modified.

### (E8) Variation Embodiment 8

In the log concentration process depicted in FIG. 10, log analysis results are displayed each time that the log concentration process is executed (refer to Step S360). However, display of log analysis results could be executed at some timing not synchronous with log concentration. That is, log analysis results could be displayed when the system administrator carries out a predetermined operation to display the log analysis results, or displayed at some periodic timing, such as once hourly or once daily.

Having described a preferred embodiment of the invention with reference to the accompanying drawings, it is to be understood that the invention is not limited to the embodiments and that various changes and modifications could be effected therein by one skilled in the art without departing from the spirit or scope of the invention as defined in the appended claims.

What is claimed is:

1. A computer system connecting a computer to a network, comprising:
a storage device that stores data received from said computer over a network; and
a log concentration device that concentrates log information from a server device group connected to said network,
wherein said storage device comprises:
a settings information receiving unit that receives as a part of settings information an address of a predetermined server device that, of said server device group, is required for operation of said storage device on said network;
an operational setting unit that performs settings to initiate operation on said network on the basis of said received settings information; and
a settings information notifying unit that notifies said log concentration device of said address included in said settings information;
and wherein said log concentration device comprises:
a concentration target designating unit that designates a server device targeted for concentration of log information, on the basis of said address given in the notification by said storage device; and
a log information concentrating unit that concentrates said log information from said designated server device.

2. A computer system according to claim 1,
wherein the settings information receiving unit of said storage device receives said settings information from an management terminal connected to said storage device.

3. A computer system according to claim 2,
wherein said management terminal is connected to said storage device by means of an management network different from said network.

4. A computer system according to claim 3,
wherein said log concentration device is connected to said management network; and
said network and said management network are connected by a gateway that selectively passes said log information.

5. A computer system according to claim 1,
wherein the log information concentrating unit of said log concentration device, by filtering on the basis of said address, extracts log information for the server device designated by said concentration target designating unit from all log information concentrated from said server device group.

6. A computer system according to claim 1,
wherein the settings information receiving unit of said storage device receives a port number in addition to said address as a part of said settings information; and
the concentration target designating unit of said log concentration device designates a server device targeted for concentration of said log information on the basis of said address and said port number.

7. A computer system according to claim 1,
wherein said server device group includes at least one type of server selected from a DNS server, an NTP server, a domain controller, and an NIS server.

8. A storage device for storing data received from a computer over a network, comprising:
a settings information receiving unit that receives as a part of settings information an address of a predetermined server device required for operation of said storage device to be operated on said network;
an operational setting unit that carries out settings to initiate operation on said network on the basis of said received settings information; and
a log concentration control unit that notifies a log concentration device that concentrates log information from a server device group connected to said network, of the address included in said received settings information, in order to cause said log concentration device to concentrate log information of the server device corresponding to said address from among said server device group.

9. Log concentration control method for controlling concentration of log information by a storage device that stores data received from a computer over a network comprising:
receiving an address of a predetermined server device required for operation of said storage device on said network as a part of settings information;
setting an initiate operation on said network on the basis of said received settings information; and
providing the log concentration device which concentrates log information from a server device group connected to said network, with notification of the address included in said settings information, to cause said log concentration device to concentrate log information from the server device corresponding to said address from among said server device group.
